(19) United States
(12) Patent Application Publication
(10) Pub. No.: US 2018/0158009 A1
(43) Pub. Date: Jun. 7, 2018

(54) FRESH PRODUCTION PLANNER

(71) Applicant: Wal-Mart Stores, Inc., Bentonville, AR (US)

(72) Inventors: Latisha Moon, Bentonville, AR (US); Gregory D. Dixon, Rogers, AR (US); Lacrecia Lynn Billings, Rogers, AR (US); James Cheek, Bella Vista, AR (US)

(21) Appl. No.: 15/831,520

(22) Filed: Dec. 5, 2017

Related U.S. Application Data
(60) Provisional application No. 62/430,095, filed on Dec. 5, 2016.

(51) Int. Cl. G06Q 10/06; G06Q 30/02; G06Q 30/06; G06Q 10/08

(52) U.S. Cl. CPC G06Q 10/06315; G06Q 10/087; G06Q 30/06; G06Q 30/0202

(57) ABSTRACT

A system is described for maximizing sales of perishable items while minimizing the waste produced. The system employs a number of stores each having at least one production department, such as a bakery or deli department, etc. The stores are linked to a corporate computing entity having a central CPU and corporate database. Each of the stores keeps a history of items made and sold for many time periods. The items sold for past equivalent time periods is used as an estimate of the number items to make. The corporate computing entity can determine a model store which has the best performance. The production plan for the model store is normalized and used to adjust the production plan. These numbers are calculated and rolled out just before they are needed from the east coast time zone through the farthest west time zone.

### CROSS-REFERENCE TO RELATED APPLICATIONS

This application claims the benefit and priority of U.S. Patent Application No. 62/430,095, entitled FRESH PRODUCTION PLANNER, filed on Dec. 5, 2016, the contents of which are hereby incorporated by reference.

### FIELD

The present invention relates to a system that produces and presents an optimum number of perishable items for sale in a retail store, and more specifically to a system that produces and presents an optimum number of perishable items for sale in a retail store that maximizes sales and minimizes waste.

### BACKGROUND

When making perishable items for retail sales, such as bakery items or deli items there is the problem of over producing, or under producing items. Making and presenting more items usually increases sales. However, this could also lead to a larger number of items being sold at reduced prices or being thrown away as waste, cutting into profits.

Some items degrade more quickly than others. Also, items are more difficult to sell once they are no longer fresh. Therefore, these may be made several times each day. This further complicates the problem of now having to determine how many items to make multiple times during the day. Sales of items typically change over the course of the day. For example, egg sandwiches are popular early in the morning but less so late in the day.

Also, customers increasingly buy entree-type dinners after 4 pm. The number of each item to make at each time period of each day is referred to as a ‘production plan’. Each production department, such as a bakery or deli, would need a production plan before they begin making items each day. In the case of a bakery, they typically only bake items in the morning. In the case of a deli, they typically make items several time periods a day. Therefore, the production plan for the deli has multiple entries for each item corresponding to the multiple time periods per day that the items are produced.

If the production planner is calculated too far in advance, it becomes “stale” and loses accuracy. If the production planner is calculated too late, the production departments have already begun making their items.

Currently, there is a need for a method to determine a system that creates an optimum number of perishable items at multiple time periods throughout each day, to maximize sales and minimize waste.

### BRIEF SUMMARY

According to aspects of the present inventive concepts there is provided an apparatus and method as set forth in the appended claims. Other features of the inventive concepts will be apparent from the dependent claims, and the description which follows.

The current invention may be embodied as a system for producing, presenting and selling an optimum number of perishable items in a predetermined time period, having a number of stores for making, presenting, selling, and discarding a plurality of perishable items, a corporate database adapted to store information provided to it, and a central CPU coupled to the plurality of the stores and the corporate database. The central CPU is adapted to receive information indicating the net sales of each of a plurality of items from each of the stores for a predetermined time period, storing the received information in the corporate database, normalizing the received information for a difference in overall sales of the stores, identifying the production facilities having net sales of the item for the current time period above a predetermined amount as model production facilities, acquiring a production plan of a model store wherein the production plan indicates a number of items to produce for a plurality of time periods, and identifying the acquired production plan as the model production plan numbers. The central CPU then normalizes the model production plan numbers for each store and adjusts the production plan numbers for each store based upon the normalized production plan numbers, resulting in an optimum number of items to produce in the predetermined time period.

The net sales are defined as sales of an item in a time period offset by a number of items made and not sold for the same time period.

Each store has a Point of Sale (POS) device adapted to acquire information on the items sold, a local database adapted to store information provided to it, at least one production department adapted to make the items, the production department having a display area adapted to display a limited number of items, and a local CPU coupled to the POS and the local database. The local CPU is adapted to receive information on sales of items and the time of sales from the POS, store the sales information in the local database, and estimate sales for a given time period, based upon previous sales.

The current invention may also be embodied as a method of increasing sales and decreasing waste of at least one perishable item made and sold in a plurality of stores that includes identifying in a selected store a modular display size available for the items, identifying inventory of the selected store available to make the perishable items, and determining the maximum number of items that can be made and displayed in the selected store. It also includes the steps of defining a time period to estimate a number of items to make, and estimating net sales of the selected item for this store for the current time period. The step of estimating net sales is repeated for a plurality of time periods, items and stores. Next, a set of corporate adjustments are calculated, and the estimated net sales are adjusted by the corporate adjustments to result in the adjusted production numbers for each item for each store. The system makes and displays the adjusted production number of items needed to maximize sales and minimize waste.

The set of corporate adjustments is calculated by acquiring estimated numbers of items to make and present for the current store, acquiring net sales of this item from net sales of a plurality of other production facilities for the defined time period, normalizing the net sales to adjust for store size, and identifying the store that has the highest normalized net sales for this item in this time period as a model store. Production plan numbers are acquired for this model store for the selected time period, the production planning numbers are normalized, and the normalized production plan numbers are used as the corporate adjustments.

The invention may also be embodied as a fresh production planner system which determines an optimum number of perishable items to make that maximizes sales and minimizes waste, having a plurality of stores each having a production department for making perishable items having at least one modular display area, a point of sale (POS) device adapted to acquire sales information relating to the items sold, and a local database having pre-stored information including the size of the modular display area in a current store available to present items, a current amount of inventory for making each item, and previous sales information of the item. The system also includes a local CPU coupled to the local database. The local CPU is adapted to calculate net sales for a current time period by analyzing plurality of equivalent previous time periods, identifying maximum number of items that can be made based upon modular display size and amount of inventory, and cap the average sales by the maximum number. The system also includes a corporate computing entity adapted to acquire the capped average sales for each item for the current time period, acquire the average sales for each item for the current time period from a plurality of other production departments, normalize the average net sales from each of the other production departments, determine at least one production department having desirable net sales for this item and identifying them as a model production department, acquire the production plan for the model production department for this item, and adjust the current production plan with the acquired production plan.

The system further includes a production department adapted to make, present and sell the number of items indicated in the final production plan for each time period to result to maximize sales and minimize waste.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 is a simplified block diagram of a fresh production planner system according to an embodiment of the current invention.

FIGS. 2 and 3 together represent a flowchart indicating a process according to one embodiment of the current invention.

FIG. 4 is a more detailed description of the steps which make up step 220 of FIG. 2.

### DETAILED DESCRIPTION

Theory

The current concept deals with a system for producing an optimum number of items to make for each production department of each store for each time period. This system may be implemented for multiple stores. There can be a single time period per day, such as when the production department is a bakery, or there can be multiple time periods per day, such as when the production department is a deli.

An indication of how many of each item to make per time period is referred to as a production plan. Therefore, the production plan is a recommendation provided at least once a day which indicates the number of each item to produce for each time period. Typically, these production plans are for a single day.

One way to estimate future sales of an item is by calculating them from previous sales of the same item. Sales of an item may vary by day of the week, day of the month, day of the year, and also vary if the day is designated as a holiday. Sales also vary from weekday to weekend. Sale variations have cyclic characteristics to them. Usually sales on a Tuesday would be more similar to sales on previous Tuesdays than it would be to sales on a Friday (assuming no holidays). Therefore, accuracy increases when the system chooses previous time periods which have a great deal of similarity to the time period for which sales are being predicted.

Not only is the day important, but the time of day is also important. This estimation is more accurate when the previous time periods selected have greater similarity to the time period for which the estimates are being calculated. Similar time periods are referred to as “equivalent” time periods.

Not only are past sales of a given store useful in predicting how many items to make, but also past sales from other stores that sell the same or very similar item are helpful. Therefore, sales figures and production numbers for the same item from other production facilities in stores of a chain of stores would be helpful in estimating a production plan for a selected store.

If many of these other stores are connected to a central processing entity the information can be acquired and shared across all stores quickly. Therefore, it can be determined which stores are having the best results. This can be further drilled down to determine by item, and by time period, which stores are having the best results. Some stores are significantly busier and therefore have greater overall sales and inventories than others. Therefore, the production plan numbers can be normalized relative to the selected store, to put them all on the same footing. These can be normalized by the relative sales, inventories, number of customers, etc. between the two stores, or between a store and a group of stores. The normalized production plan can then be used to update the estimated production plan numbers of each store to maximize the number of items sold and minimize waste.

In alternative embodiments, there may be additional factors that are considered to adjust the production plan numbers. For example, the central processing entity may look at an overall average of stores sales increases for a holiday, and increase the production plan numbers accordingly. Similarly, the central processing entity can take into account the sales from the same time period in previous weeks or months, and the overall economy change over that period and adjust production plan numbers accordingly. There are many other commonly known methods of predicting and adjusting sales numbers which also may be implemented with the current invention.

Implementation

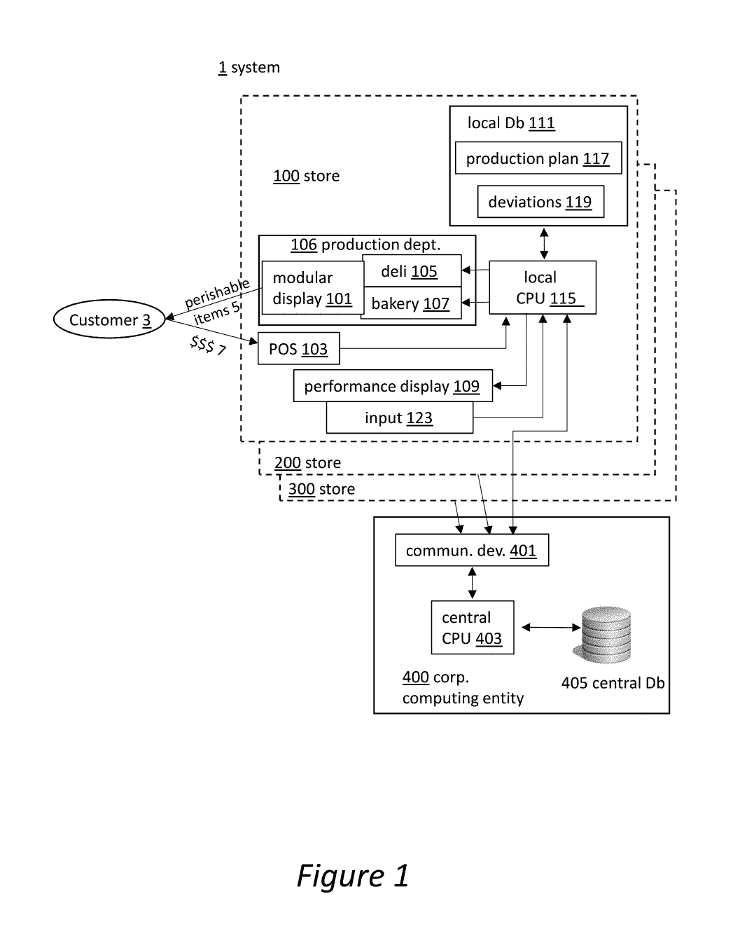

FIG. 1 is a simplified block diagram of a fresh production planner (FPP) system according to an embodiment of the current invention. The system 1 includes a plurality of stores 100, 200, 300. Each store 100, 200, 300 includes a production department 106 which may be a deli 105, a bakery 107, or other department which makes, presents and sells perishable items.

These departments may share a common modular display 101, or individual modular displays for each production department 105, 107. The items are made and presented for sale in the modular display 101. There is a limit to how many items may be presented in the modular display 101.

Customers are able to view the items in the modular display 101, select and purchase them through point of sale (POS) device 103. The POS device 103 provides sales information to a local CPU 115 that stores it in a local database 111. This sales information includes the cost of the item sold, the date on which it was sold, and the time when it was sold. Typically, sales information is stored which goes back at least several years.

There is also at least one employee display 109 which is driven by local CPU 115 that can display feedback to the employees on how well the production departments 105, 107 are performing.

These stores 100, 200, 300 are coupled to, and communicate with a corporate computing entity 400. The corporate computing entity 400 includes a communication device 401 allowing a central CPU 403 to communicate with each of the stores 100, 200, 300.

Central CPU 403 is also coupled to corporate database 405. Central CPU 403 stores information in and retrieves information from the corporate database 405.

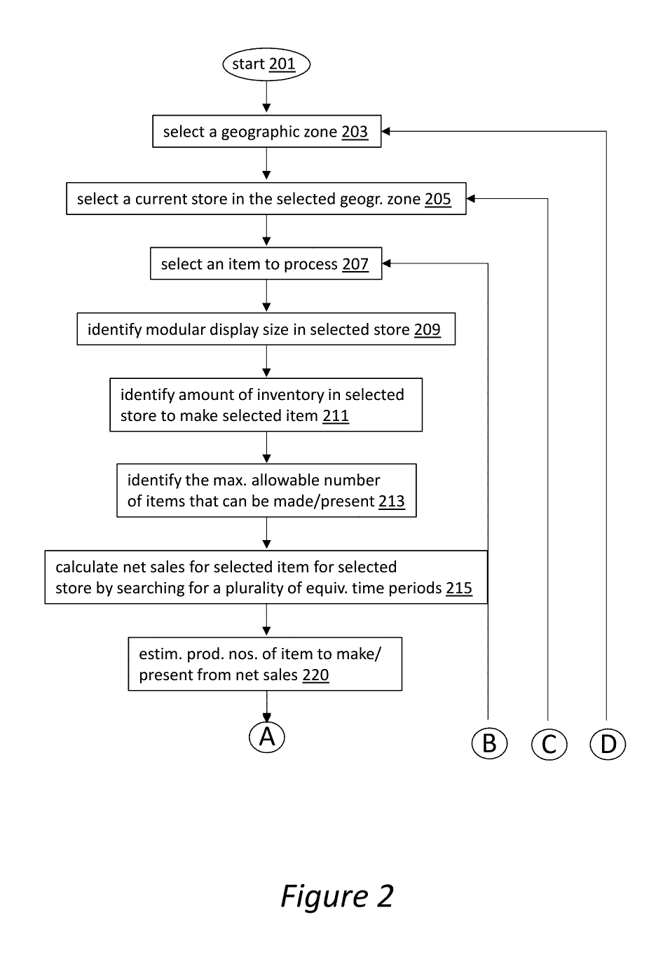

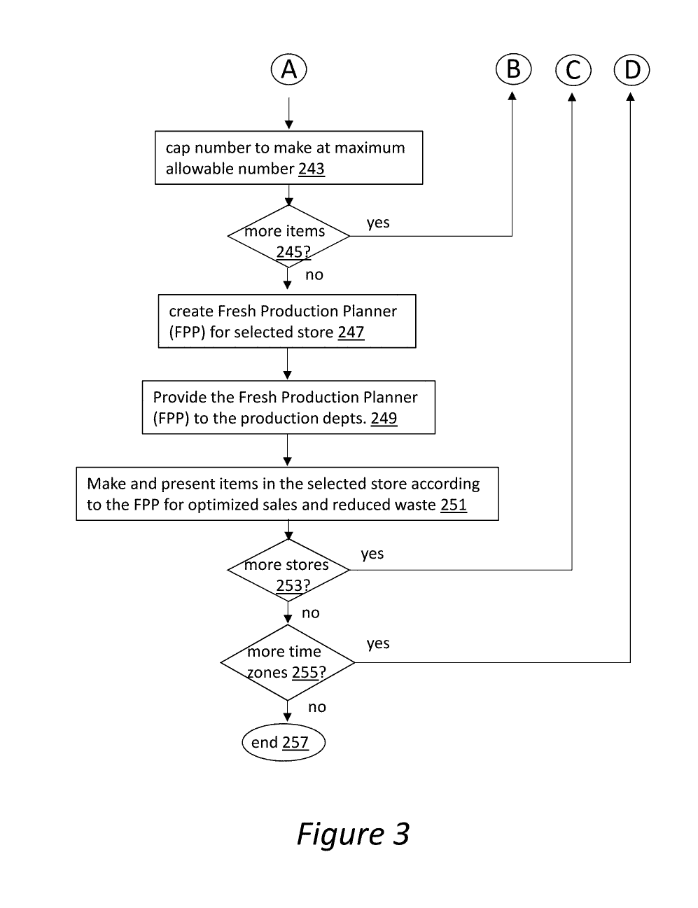

FIGS. 2 and 3 together represent a flowchart indicating a process according to one embodiment of the current invention. The structure and functioning of the current invention will be described in connection with FIGS. 1, 2, and 3.

The process starts at step 201. Note that since all of the local CPUs 115 are connected to and communicate with central CPU 403, they can share all information which either can access. The same is true in the other direction in which the central CPU 403 can provide information to the local CPUs 115.

In step 203, it is determined by central CPU 403 which geographic zone is being processed, which may be referred to as the ‘current’ geographic zone. These typically pertain to a time zone. Due to time difference between geographic zones, the system 1 processes production plans for stores in the eastern-most geographic zones first and provides the production plan to these stores before calculating and providing information for stores in geographic zones to the west. This allows the freshest information to be used in the calculations and therefore be more accurate and timely. It also provides the information when store associates are present in the stores.

In step 205, central CPU 403 selects a store and its production department(s) for which a production plan is being created. This will be referred to as the ‘current’ store and the ‘current’ production department(s).

In step 207, an item is selected by central CPU 403 to be the item for which the production plan is to be calculated. This may also be referred to as the ‘current’ item 5.

In step 209, central CPU 403 communicates with local CPU 115 to search through local database 111. Alternatively, local database 111 is periodically uploaded to central database 405, and central database 405 is searched by central CPU 403 to find the size of the modular display 101 of the selected store available to present the selected item 5.

In step 211, central CPU 403 communicates with local CPU 115 to search through local database 111. Alternatively, local database 111 is periodically uploaded to central database 405, and central database 405 is searched by central CPU 403 to find the appropriate inventory in stock to make the selected item.

In step 213, central CPU 403 communicates with local CPU 115 to search through local database 111. Alternatively, local database 111 is periodically uploaded to central database 405, and central database 405 is searched by central CPU 403 to find the maximum number of items that can be made and displayed based upon the size of the modular display and the amounts of inventory in stock.

In step 215, central CPU 403 communicates with local database 111 through local CPU 115. Alternatively, local database 111 is periodically uploaded to central database 405 and central database 405 is searched by central CPU 403 to find the time periods equivalent to the time period for which it is currently calculating items to make for the production plan. The numbers from ‘equivalent’ time periods are combined. The way in which these are combined may be a straight average of each of the numbers going back a predetermined number of weeks.

In an alternative embodiment, the numbers from equivalent time periods for the same item may be combined as a weighted average in which the numbers which are more recent have a higher weighting factor than those that are older. This allows more recent data to have a greater impact upon the estimate. There also are many other currently known methods of combining periodic data to result in an estimate that may be used here, all of which fall under the spirit of the current invention.

In some cases, all items made are sold before the time period is over. The items were sold out. This implies that if more items were made in the time period, the number of sales could have been higher. Since the POS keeps track of the number of items sold and the time of each sale, the system knows the beginning and end of each time period, and also knows the number of items made for each time period. It can determine if the items have sold out before the end of the time period. In an alternative embodiment, the sales numbers for time periods in which all items have sold out before the time period ended, can be discarded and numbers from another equivalent time period can be used in its place.

In an alternative embodiment, there may be some additional calculations. For example, sales trends for the current item for the store, may also be taken into account. If it appears that sales of the current item have been increasing over the last several weeks, the estimate may be adjusted upward.

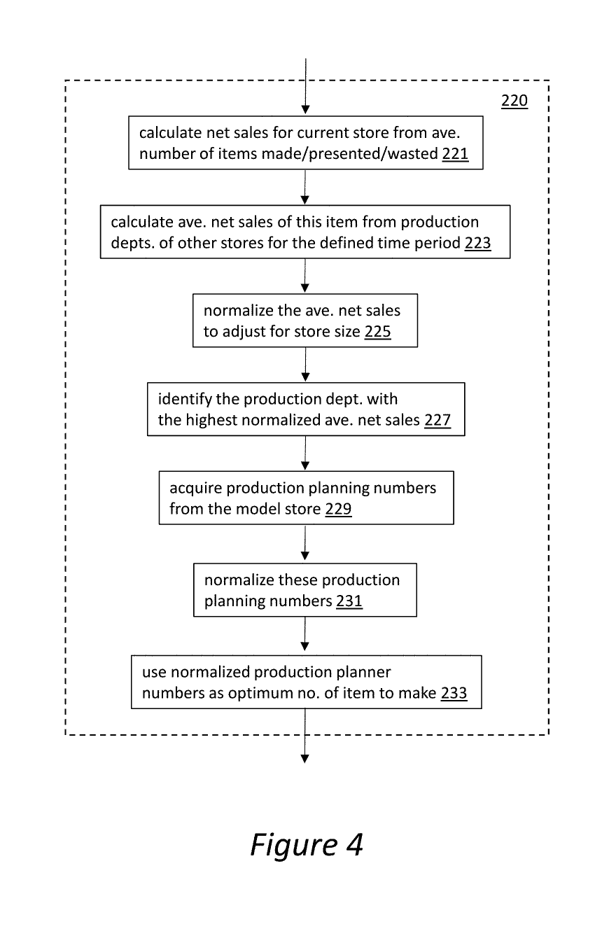

In step 220, estimated numbers of items to make are calculated by the corporate computing entity 400. This step is described in greater detail in FIG. 4.

In step 243, the estimated numbers for each time period are capped by the maximum number of each item that the current store can display/make.

In step 245, if there are more items to process for the current store (“yes”), processing continues back at step 207 for the next item 5 and the process is repeated for this next item.

In step 245, if central CPU 403 indicates that there are no more items for the selected store to be processed (“no”), the FPP for the selected store is finalized and provided to the production departments 105, 107 to begin production.

In step 247 the Fresh Production Planner (FPP) is created which includes the number of each item to make for at least one time period for all items of a production department 106.

In step 249 the FPP is provided to the production department.

In step 251, the production departments 105, 107 create, display and sell items 5 according to the created production planner.

In step 253, the central CPU 403 determines if there are more stores in the current time zone that have not yet received an FPP. If so (“yes”), then central CPU 403 identifies a store for which an FPP has not yet been created as the current store in step 205, and the process continues.

In step 253 there are no additional stores in the current geographic zone that still need an FPP (“no”), then processing continues in step 255.

In step 255, it is determined if there are any other geographic zones left to process. If so, (“yes”), then processing continues at step 203 and a production planner is created for all items of all stores in the next geographic zone.

In step 255, if a production planner was created for all items of all of the stores in all of the geographic zones, and there are no more FPPs to be created, (“no”), then process ends in step 257.

FIG. 4 is a more detailed description of the steps which make up step 220 of FIG. 1.

In step 221, the central CPU 403 calculates an average net sale of the current item 5 for the current store from an average number of items made and wasted.

In step 223, central CPU 403 calculates net sales for the current item from other stores 200, 300 for the same defined time period.

In step 225, the net sales of the current item acquired from the other stores 200, 300 are normalized by central CPU 403 to adjust for the differences in store size and/or sales so that they may be compared.

In step 227, one or more stores having the best normalized net sales of the current item for the current time period are identified by the central CPU 403 as ‘model’ stores.

In step 229, the production plan numbers for the current item and time period are acquired from the model stores.

In step 231, the acquired production plan numbers are normalized by the relative size/sale between the current store and the model store.

In step 233, the acquired estimated numbers are adjusted by the normalized production plan numbers from the model stores to result in an optimum number of the item to make for the current time period.

Referring back to FIG. 1, local CPU 115 acquires actual net sales for each item 5 for at least one past time period of a store 100, 200, 300 from the local database 111;

The actual net sales for this store are compared to the production planner numbers for at least one previous time period to determine performance.

The local CPU 115 activates at least one employee display 109 to indicate performance for at least one past time period.

In one embodiment, at least one employee display 109 is color coded as to performance. For example, yellow could mean that there were too many items produced and there was a high number of items wasted. Red could mean that items sold out before the time period was over, indicating lost sales. Green would mean that the items made were in a predetermined acceptable range.

The system 1 may have several employee displays, such as one indicating performance for the previous week, one for the previous four weeks, one for the previous eight weeks, and one for the previous twelve weeks.

As indicated above, most of the processing at the store level is done by the local CPU 115 and the processing which requires information from multiple stores is performed by the central CPU 403. However, in an alternative embodiment, the local stores 100, 200, 300 can be connected to each other and one of the local CPUs 115 is designated as a master CPU. It can then perform its own functions as well as those of the central CPU 403. If it has all of the functionality and data required to perform the functions of the central CPU 403, then it (the central CPU 403) can be eliminated in this embodiment.

The above processing was described to determine the number of items to make, however, the same process can be used to determine the number of items to present in the modular display 101 of each production department 106. The process finds one of the stores having the highest net sales for the item in the same time period and uses the numbers it displayed for all other stores (capped by the number each store can make and display).

The system was described in which the local CPU 115 acquired data and stored it in local database 111. However, in an alternative embodiment, local CPU 115 can find equivalent time periods, determine averages for these time periods, and estimate the number of each item for each time period for this store to make.

The central CPU 403 then finds the model stores for this item and time period or time period(s), and acquires its make/display numbers. These are then merged with the make/display numbers calculated by each store to adjust them.

Any number of conventional means may be used to adjust the local stores' make/display numbers using the model store's make/display numbers. One such method is to average the ‘make number’ for the model store and the local store for an item for a time period. Another way to merge these numbers is to weight them and then average them. There are multiple ways to merge these numbers which may be based upon the age of the number, a measure of the dissimilarity of the model store and the local store, sales trends of either or both the model store or the local store, etc.

Although a few examples have been shown and described, it will be appreciated by those skilled in the art that various changes and modifications might be made without departing from the scope of the invention, as defined in the appended claims.

What is claimed is:

1. A system for producing, presenting and selling an optimum number of perishable items in a predetermined time period, comprising:
a plurality of stores for making, presenting, selling, and discarding a plurality of perishable items;
a corporate database adapted to store information provided to it;
a central CPU coupled to the plurality of the stores and the corporate database, and is adapted to:
receive information indicating the net sales of each of a plurality of items from each of the stores for a predetermined time period,
store the received information in the corporate database;
normalize the received information for a difference in overall sales of the stores;
identify the production facilities having net sales of the item for the current time period above a predetermined amount as model production facilities,
acquire a production plan of a model store wherein the production plan indicates a number of items to produce for a plurality of time periods;
identify the acquired production plan as the model production plan numbers;
normalize the model production plan numbers for each store;
calculate the production plan numbers for each store based upon the normalized production plan numbers, resulting in an optimum number of items to produce in the predetermined time period.

2. The system of claim 1, wherein net sales are defined as sales of an item in a time period offset by a number of items made and not sold for the same time period.

3. The system of claim 1, wherein each store comprises:
a POS device adapted to acquire information on the items sold;
a local database adapted to store information provided to it;
at least one production department adapted to make the items, the production department having a display area adapted to display a limited number of items;
a local CPU coupled to the POS and the local database adapted to:
receive information on sales of items and the time of sales from the POS,
store the sales information in the local database,
store markdown and waste information in the local database, and
store product shelf life information.

4. The system of claim 3 wherein the production department may include at least one of a bakery, and a deli.

5. The system of claim 3, wherein central CPU is further adapted to:
acquire a production plan from the production plan storage for at least one previous time period;
acquire information from the local database of actual items sold for the same time periods and determine a deviation from the pre-stored production plan;
store the deviation in a deviation storage;
display an indication of the magnitude of the deviation on an employee display for a plurality of time periods.

6. The system of claim 3 further comprising:
an input device coupled to the local CPU allowing a count of items not sold to be input to the system.

7. A method of increasing sales and decreasing waste of at least one perishable item made and sold in a plurality of stores, comprising the steps of:
identifying in a selected store a modular display size available for the items;
identifying inventory of the selected store available to make the perishable items;
determining the maximum number of items that can be made and displayed in the selected store;
defining a time period to estimate a number of items to make;
estimating net sales of the selected item for this store for the current time period;
repeating the prior step for a plurality of time periods, items and stores;
calculating a set of corporate adjustments to the estimated net sales;
adjusting each estimated net sales by the corporate adjustments to result in the adjusted production numbers for each item for each store;
making and displaying at the store, the adjusted production number of items needed to maximize sales and minimize waste.

8. The method of claim 7 wherein the set of corporate adjustments is calculated by:
acquiring estimated numbers of items to make and present for the current store;
acquiring net sales of this item from net sales of a plurality of other production facilities for the defined time period;
normalizing the net sales to adjust for store size;
identifying the store that has the highest normalized net sales for this item in this time period as a model store;
acquiring the production planner numbers for this model store for the selected time period;
normalizing these production planning numbers; and
using the normalized production planner numbers as the corporate adjustments.

9. The method of claim 7 wherein corporate adjustments are calculated by:
acquiring estimated numbers of items to make and present for the current store;
acquiring net sales trends of this item from net sales of a plurality of other production facilities for the defined time period;
normalizing the net sales trends to adjust for store size;
identifying the store that has the highest normalized net sales trends for this item in this time period as a model store;
acquiring the production planner numbers for this model store for the selected time period;
normalizing these production planning numbers; and
using the normalized production planner numbers as the corporate adjustments.

10. The method of claim 7, wherein the step of estimating net sales comprises:
averaging the net sales of the same item from the same store over a plurality of equivalent other past time periods.

11. The method of claim 7, further comprising the steps of:
acquiring actual net sales for each item for at least one past time period of the store;
comparing the actual net sales to the production planner numbers for the at least one previous time period to determine performance;
activating at least one performance display indicating performance for at least one past time period.

12. The method of claim 11, wherein the at least one performance display is color coded as to performance.

13. The method of claim 11 wherein the past time periods include at least one of:
a previous week, a previous four weeks, a previous eight weeks, and a previous twelve weeks.

14. The method of claim 7, wherein the adjusted production numbers are capped to be no more than the maximum number of items that can be made and displayed in the selected store.

15. The method of claim 9, wherein the net sales are the sales of the item adjusted for items not sold.

16. A fresh production planner system which determines an optimum number of perishable items to make that maximizes sales and minimizes waste, having a plurality of stores, each comprising:
a production department for making perishable items having at least one modular display area;
a point of sale (POS) device adapted to acquire sales information relating to the items sold;
a local database having pre-stored information on:
the size of the modular display area in a current store available to present items, a current amount of inventory for making each item, and
previous sales information of the item;
a local CPU coupled to the local database, the local CPU adapted to:
acquire sales, waste, and other information for a plurality of items for a plurality of time periods, and
store the acquired information in a local database,
a corporate computing entity adapted to:
calculate net sales for a current time period by analyzing a plurality of equivalent previous time periods,
identify maximum number of items that can be made based upon modular display size and inventory available at each store for each item,
cap the net sales by the maximum number for each item;
acquire the capped average sales for each item for the current time period,
acquire the average sales for each item for the current time period from a plurality of other production departments,
normalize the average net sales from each of other production departments,
determine at least one production department having desirable net sales for each item and identifying them as model production department,
acquire the production plan for the model production department for each item, and
adjust the current production plan with the acquired production plan.

17. The system of claim 16 further comprising a production department adapted to make, present and sell the number of items indicated in the final production plan for each time period to maximize sales and minimize waste.

18. The system of claim 16 wherein equivalent time periods are at least two time periods which have at least one of the same time of day, day of the week, day of the year, and holiday designation.

19. The system of claim 16 further comprising:
an input device to manually input information into the system that cannot be easily sensed by the system.

20. The system of claim 16 further comprising a performance display adapted to display information provided to it; and
wherein the central CPU is adapted to:
acquire a production plan from the production plan storage for at least one previous time period;
acquire information from the local database of actual items sold for the same time periods and determine a deviation from the pre-stored production plan;
store the deviation in a deviation storage;
display an indication of the magnitude of the deviation on the performance for a plurality of time periods.
